(19) United States
(12) Patent Application Publication
(10) Pub. No.: US 2023/0015340 A1
(43) Pub. Date: Jan. 19, 2023

(54) Door Assembly Allowing Improved Installation on the Walls of an Enclosure, and Enclosure Comprising Such a Door Assembly

(71) Applicant: ABC TRANSFER, Tours (FR)

(72) Inventors: Julien FELIX, Tours (FR); Jean-Luc SCHNEIDER, Sligo (FR); Thierry GIRARD, Tours (FR)

(21) Appl. No.: 17/787,195

(22) PCT Filed: Dec. 17, 2020
(86) PCT No.: PCT/FR2020/052503

§ 371 Date: Jun. 17, 2022

(30) Foreign Application Priority Data
Dec. 19, 2019 (FR) 1914959

(51) Int. Cl. E06B 5/00; E06B 1/52; E06B 1/60; E05C 19/00

(52) U.S. Cl. CPC E06B 5/00; E05C 19/00; E06B 1/52; E06B 1/6046; G21F 7/005

(57) ABSTRACT

The invention relates to a door assembly (1) for a sealed enclosure, said enclosure comprising a wall having a wall portion (20) defining at least one passage opening therein, said door assembly (1) comprising a flange (3) intended for being attached to the wall portion (20), characterized in that the flange (3) comprises two flange elements (3a, 3b) assembled together, one of the flange elements (3a) defining a ring inside the enclosure, the other flange element (3b) defining a ring outside the enclosure, and means for clamping at least one of the two flange elements (3a, 3b) against the wall portion (20).

### TECHNICAL FIELD OF THE INVENTION

The present invention relates to a door assembly intended to equip a first enclosed volume and able to allow a sealed connection of a second enclosed volume on the first enclosed volume for the transfer of products from one to the other without breaking the containment. This may include, for example, the transfer of hazardous products such as certain biological, chemical or radioactive products, the transfer of components such as stoppers, vials, plungers, syringes, etc., the transfer of environmental control devices such as culture medium plates, particle counters, etc., the transfer of cleaning systems, the transfer of liquids, powders, tools, the transfer of waste to the outside of the enclosure and/or the transfer of any element necessary to production or maintenance of the production line.

In the present application, “volume” means any product, equipment or installation delimiting a volume. Thus, it can be an enclosure, an insulator, a receptacle, a container, a bag, etc.

“Enclosed volume” is understood to mean a volume isolated from the external environment. This may be in particular, but not exclusively, a volume for preparing, storing and/or handling products that must not be in contact with the outside or with a user.

The door assembly is intended in particular, but not exclusively, to be installed on an enclosure having a glass wall.

### PRIOR ART

The transfer of products from one enclosed volume to another without breaking the containment of these volumes is a difficult problem to solve. To respond to this problem, double-door sealed connection devices have been developed. This includes, for example, those described in patent applications FR2777822 and FR3036054.

These double-door connection devices are formed by a first and a second door/flange assembly, one of the door/flange assemblies being that of one of the volumes, the other door/flange assembly being that of the other volume. Conventionally, the enclosed volume to be connected is a receptacle of the transportable container or pouch type, while the other enclosed volume to which the receptacle is connected is generally a fixed handling enclosure. The receptacle is connected to the handling enclosure by connecting the door/flange assemblies together. This connection is generally made by the engagement of what is referred to as a bayonet system―male lugs of the flange and the door of the receptacle engaging, respectively, in notches of the flange and the door of the other enclosure-followed by a rotation of the receptacle that allows the flange of the receptacle to be locked to the flange of the handling enclosure, as well as allowing the door of the receptacle to be locked to the door of the enclosure, the doors connected to one another being unlocked by unlocking the doors from the respective flanges thereof.

In the equipment of the prior art, the door assemblies are generally fixed to the walls of the enclosure by screwing the flanges directly onto the walls of the enclosure. Patent application FR2834582 shows such an arrangement. Such fixing, however, proves to be problematic when the walls of the enclosure are made of relatively fragile materials such as walls made of glass or of transparent plastic, such as PMMA (polymethyl methacrylate), the latter being able to be damaged due to being passed through by the assembly screws and consequently having weakened areas and therefore a risk of breaking of the containment.

The invention aims to remedy these problems by proposing a door assembly, and an enclosure comprising such a door assembly, that can be assembled simply, quickly and easily without altering the walls of the enclosure on which it is installed.

### SUBJECT MATTER OF THE INVENTION

To this end, and according to a first aspect, the invention proposes a door assembly for a sealed enclosure, said enclosure comprising a wall having a wall portion defining at least one passage opening therein, said door assembly comprising a flange intended for being attached to the wall portion defining the passage opening and a leaf mounted movable relative to the flange between a closed position in which the leaf closes the passage opening and an open position, characterized in that the flange comprises two flange elements assembled together, one of the flange elements defining a ring inside the enclosure and having a bearing surface arranged to bear on the inner surface of the wall portion, the other flange element defining a ring outside the enclosure and having a bearing surface arranged to bear against the outer surface of the wall portion, the flange further comprising means for clamping at least one of the two flange elements against the wall portion.

The wall of the enclosure is thus “sandwiched” between the inner and outer rings and clamped between the latter by means of the clamping means, the clamping being carried out from ring to ring without the wall 2 of the enclosure being passed through.

The two flange elements are separate and independent parts from each other. They are assembled to each other in a reversible manner.

Advantageously, the door assembly comprises at least one protective washer intended to be placed between the bearing surface of at least one of the flange elements and the wall portion.

Advantageously, the door assembly comprises at least one seal intended to be inserted between the bearing surface of at least one of the flange elements and the wall portion.

Advantageously, the door assembly comprises a spacer arranged to be placed between two wall elements forming the wall of said enclosure.

Advantageously, the door assembly is arranged to allow the sealed connection of a door assembly equipping a container by means of a bayonet system.

The invention also relates to a sealed enclosure comprising at least one passage opening provided with a door assembly as described above.

### BRIEF DESCRIPTION OF THE DRAWINGS

Other features and advantages of the invention will become apparent from the following detailed description of the invention with reference to the appended figures, in which:

FIG. 1 shows a first embodiment of a door assembly installed on a single enclosure wall;

FIG. 2 shows a cross-sectional view of the door assembly of FIG. 1;

FIG. 3 shows a second embodiment of a door assembly installed on a double enclosure wall;

FIG. 4 shows a cross-sectional view of the door assembly of FIG. 3.

For greater clarity, identical or similar elements of the various embodiments are denoted by identical reference signs in all of the figures.

### DETAILED DESCRIPTION OF THE INVENTION

In the following, the terms “outer” and “inner” are defined with respect to the enclosure on which the door assembly is mounted. Thus, the term “outer” designates what is located outside the interior space of the enclosure, the farthest from the interior space or directed away from the interior of the enclosure, and “inner” designates that which is located in the interior space, closest to the interior space or directed toward the interior of the enclosure.

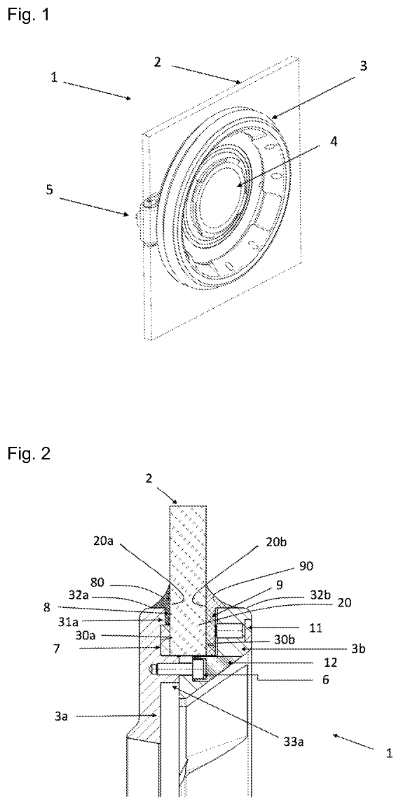

In relation to FIGS. 1 and 2, a door assembly 1 is described fitted to an enclosure comprising a glass wall 2 provided with at least one passage opening for the passage of products from the outside of the enclosure to the inside thereof and vice versa. As indicated above, the door assembly 1 is arranged to constitute a connection device allowing connection of an enclosed volume, such as a container, bag or the like, equipped with a door assembly cooperating with the door assembly 1 according to the invention, without breaking the containment.

The door assembly 1 comprises a flange 3 intended to be attached on the wall portion 20 defining the passage opening on the one hand and a leaf 4 mounted to move relative to the flange 3 between a closed position in which the leaf 4 closes the passage opening and an open position. In the example illustrated, the leaf 4 is installed movably on the flange 3 by a hinge 5.

According to the invention, the flange 3 of the door assembly 1 comprises two flange elements 3a, 3b that are distinct from each other and assembled to each other by means, in the example illustrated, of assembly screws 6. Advantageously, the assembly screws 6 are hidden by covers 12. In the embodiment described, the flange elements 3a, 3b are assembled directly to each other. Thus, the flange 3 is installed on the wall portion 20 of the enclosure, one of the flange elements 3a being located inside the enclosure while the other flange element 3b is located outside the enclosure. The flange elements 3a, 3b thus respectively define a ring inside the enclosure and a ring outside the enclosure. The inner and outer rings are designated below with the same references as those of the flange elements 3a, 3b.

The rings 3a, 3b have a surface 30a, 30b arranged to bear directly or indirectly on the surface of the wall portion 20 opposite which it is placed. Thus, in the example illustrated, the inner ring 3a has an outer bearing surface 30a bearing directly on the inner surface 20a of the wall portion 20, while the outer ring 3b has an inner bearing surface 30b bearing on the outer surface 20b of the wall portion 20. With regard to the outer ring 3b, the bearing is achieved by set screws 11 housed in holes made in the outer ring 3b and projecting from the inner bearing surface 30b.

In order to prevent damage to the glass wall of the enclosure during installation of the door assembly 1, two protective washers 7, 9, advantageously made of plastic material, are interposed respectively between the inner ring 3a and the wall portion 20 on the one hand and between the outer ring 3b and the wall portion 20 on the other hand. These protective washers are subsequently referred to as inner 7 and outer 9 protective washers. In the illustrated embodiment, the inner protective washer 7, of annular shape, is housed in a groove defined by the peripheral rim 31a of the inner ring and a circular collar 33a outside the inner ring 3a. The outer washer 9 in turn comprises an annular body whose outer periphery is provided with a heel 90 extending along the outer periphery 32b of the outer ring 3b firstly and along the wall portion 20.

In order to ensure that the door assembly 1 is sealed, the latter comprises at least one annular seal, advantageously made from elastomer, and preferably made from silicone, interposed between the wall portion 20 and the bearing surface of at least one of the two rings 3a, 3b. In the example illustrated, the door assembly 1 comprises a single seal 8 interposed between the peripheral rim 31a of the inner ring 3a and the wall portion 20 of the enclosure. More particularly, the seal 8 is located in the gap defined by the peripheral rim 31a of the inner ring 3a, the inner protective washer 7 and the inner surface 20a of the wall portion 20. It also has a heel 80 extending along the outer periphery 32a of the inner ring 3a on the one hand and along the inner surface 20a of the wall portion 20.

The crushing of the seal 8 is carried out using the set screws 11. The set screws 11 mounted through the outer ring 3b and extending beyond the inner bearing surface of the outer ring 3b thus press the outer protective washer 9 against the wall portion 20, pressing the latter against the inner protective washer 7 by jointly crushing the seal 8.

As indicated previously, the assembly of the rings 3a, 3b is carried out by assembly means, screws in the example, without the latter passing through the wall. The screw receiving holes are thus provided on the rings 3a, 3b to be offset radially from the edge of the wall portion 20 when the rings 3a and 3b are installed on the wall 2. In the example illustrated, the assembly screws 6 pass through the rings 3a and 3b close to the edge of the wall portion 20, the screw holes made in the inner ring being located in the circular collar 33a.

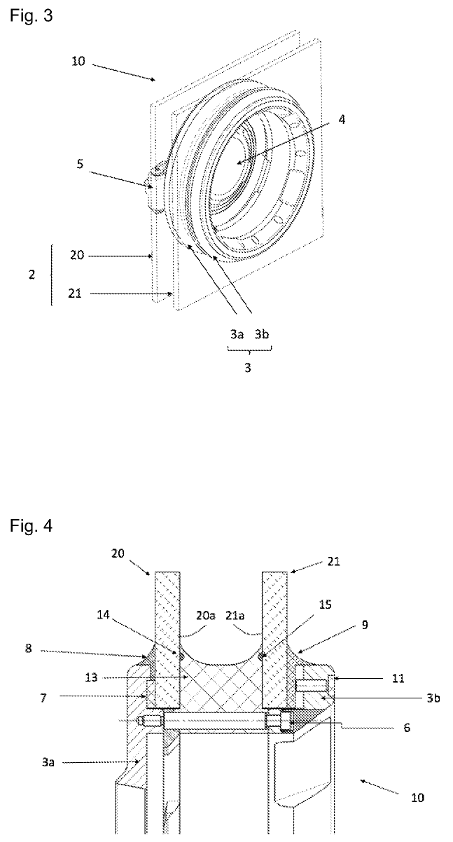

FIGS. 3 and 4 illustrate another example of installation of a door assembly 10 according to the invention. In this illustrated example, the door assembly 10 is installed on an enclosure wall formed by two wall elements 20, 21. This door assembly 10 incorporates all of the elements previously described except that the outer ring 3b and the outer protective washer 9 bear on the wall portion 21a of the outer wall element 21 while the inner ring 3a, the inner protective washer 7 and the seal 8 bear against the wall portion 20a of the inner wall element 20. Furthermore, and advantageously, the door assembly 10 further comprises a spacer 13 placed between the two wall elements 20, 21.

In this example, the spacer 13 is assembled with the flange elements 3a, 3b by means of assembly screws 6, the latter passing all the way through the spacer 13 to connect the two flange elements 3a, 3b, without passing through the wall elements 20, 21.

Two annular seals 14, 15, of substantially circular section, are placed between the spacer 13 and each of the wall portions 20a, 21a of the wall elements 20, 21. In the same way as to ensure the leaktightness on the inner side of the flange 3 with the seal 8, the leaktightness between the two wall elements 20, 21 is ensured by crushing of said seals 14, 15 via the set screws.

In the examples described, the door assemblies are described in connection with a single or double glass wall. It is of course obvious that the door assembly according to the invention is not limited to this type of enclosure, and that it can be intended for enclosures having walls made of a material other than glass without departing from the field of the invention.

The invention is described in the foregoing by way of example. It is understood that a person skilled in the art is in a position to produce various variant embodiments of the invention without thereby departing from the scope of the invention.

1. A door assembly for a sealed enclosure, said enclosure comprising a wall having a wall portion defining at least one passage opening therein, said door assembly comprising a flange attached to the wall portion defining the passage opening and a leaf mounted movable relative to the flange between a closed position in which the leaf closes the passage opening and an open position, characterized in that the flange comprises two flange elements assembled together, one of the flange elements defining a ring inside the enclosure and having a bearing surface arranged to bear on the inner surface of the wall portion, the other flange element defining a ring outside the enclosure and having a bearing surface arranged to bear against the outer surface of the wall portion, the flange further comprising means for clamping at least one of the two flange elements against the wall portion.

2. The door assembly for an enclosure according to claim 1, characterized in that it comprises at least one protective washer intended to be placed between the bearing surface of at least one of the flange elements and the wall portion.

3. The door assembly for an enclosure according to claim 1, characterized in that it comprises at least one seal intended to be inserted between the bearing surface of at least one of the flange elements and the wall portion.

4. The doorassembly for an enclosure according to claim 1, characterized in that it comprises a spacer arranged to be placed between two wall elements forming the wall of said enclosure.

5. The door assembly for an enclosure according to claim 1, characterized in that it is arranged to allow the sealed connection of a door assembly equipping a container by means of a bayonet system.

6. A sealed enclosure comprising at least one wall comprising at least one passage opening provided with a door assembly according to any of the preceding claims.

7. The door assembly for an enclosure according to claim 2, characterized in that it comprises at least one seal intended to be inserted between the bearing surface of at least one of the flange elements and the wall portion.

8. The door assembly for an enclosure according to claim 2, characterized in that it comprises a spacer arranged to be placed between two wall elements forming the wall of said enclosure.

9. The door assembly for an enclosure according to claim 3, characterized in that it comprises a spacer arranged to be placed between two wall elements forming the wall of said enclosure.

10. The door assembly for an enclosure according to claim 7, characterized in that it comprises a spacer arranged to be placed between two wall elements forming the wall of said enclosure.

11. The door assembly for an enclosure according to claim 2, characterized in that it is arranged to allow the sealed connection of a door assembly equipping a container by means of a bayonet system.

12. The door assembly for an enclosure according to claim 3, characterized in that it is arranged to allow the sealed connection of a door assembly equipping a container by means of a bayonet system.

13. The door assembly for an enclosure according to claim 7, characterized in that it is arranged to allow the sealed connection of a door assembly equipping a container by means of a bayonet system.

14. The door assembly for an enclosure according to claim 4, characterized in that it is arranged to allow the sealed connection of a door assembly equipping a container by means of a bayonet system.

15. The door assembly for an enclosure according to claim 8, characterized in that it is arranged to allow the sealed connection of a door assembly equipping a container by means of a bayonet system.

16. The door assembly for an enclosure according to claim 9, characterized in that it is arranged to allow the sealed connection of a door assembly equipping a container by means of a bayonet system.

17. The door assembly for an enclosure according to claim 10, characterized in that it is arranged to allow the sealed connection of a door assembly equipping a container by means of a bayonet system.
